(19) United States
(12) Patent Application Publication
(10) Pub. No.: US 2005/0055276 A1
(43) Pub. Date: Mar. 10, 2005

(54) Sensor incentive method

(76) Inventors: Massi E. Kiani, Laguna Niguel, CA (US); Kevin Mosher, Dana Point, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/877,798

(22) Filed: Jun. 25, 2004

Related U.S. Application Data
(60) Provisional application No. 60/483,297, filed on Jun. 26, 2003.

(51) Int. Cl. G06F 17/60

(52) U.S. Cl. 705/14

(57) ABSTRACT

A sensor incentive method provides a sensor adapted to function with an installed base of conventional physiological instruments. An incentive is associated with the sensor in connection with a sensor purchase. The incentive is applied to a qualified physiological instrument purchase so as to motivate or otherwise enable the upgrade or replacement of the installed base with advanced physiological instruments. The accumulation of multiple incentives may also apply to the purchase. In one embodiment, a coupon is associated with the sensor purchase, the coupon having a monetary value applicable to the purchase of advanced physiological instruments. The coupon is redeemed for the monetary value during the qualified purchase. Multiple coupons may be accumulated and redeemed for the monetary value times the number of coupons.

### REFERENCE TO RELATED APPLICATIONS

The present application claims benefit of U.S. Provisional Application No. 60/483,297 filed Jun. 26, 2003, entitled “Sensor Incentive Method.” The present application incorporates the disclosure of the foregoing application herein by reference.

### BACKGROUND OF THE INVENTION

The healthcare industry utilizes a variety of physiological instruments to monitor patient parameters. For example, pulse oximeters perform a spectral analysis of the pulsatile component of arterial blood in order to determine oxygen saturation, the relative concentration of oxygenated hemoglobin to depleted hemoglobin. Other examples include instruments to measure and monitor blood pressure and electrocargiograms (ECG), to name a few.

FIG. 1 illustrates a conventional pulse oximetry system 100 having a sensor 110 and a monitor 150. The sensor 110 attaches to a patient tissue site and provides a physiological signal to the monitor 150, which continuously displays patient status. The monitor 150 has LED drivers 152, a signal conditioning and digitization front-end 154, a signal processor 156 and a display 158. The LED drivers 152 alternately activate the sensor LED emitters 112, which project red and IR wavelength light into the tissue site. The front-end 154 conditions and digitizes the resulting current generated by the photodiode 114, which is proportional to the intensity of the detected light after absorption by the tissue site. The signal processor 156 inputs the conditioned photodiode signal and determines oxygen saturation based on the differential absorption by arterial blood of the two LED wavelengths. The display 158 indicates a patient's oxygen saturation and pulse rate measurements.

### SUMMARY OF THE INVENTION

Medical equipment manufacturers support an installed base of conventional physiological instruments and corresponding generic sensors for the healthcare industry. Patient and healthcare provides alike, however, can often benefit by an upgrade or replacement of this installed base to advanced physiological instruments incorporating newer technology and providing superior performance and features. For example, conventional pulse oximetry assumes that arterial blood is the only blood moving or pulsating in the measurement site. During patient motion, the venous blood also moves, which causes conventional pulse oximetry to under-read because it cannot distinguish between the arterial and venous blood. In advanced pulse oximetry, signal processing identifies the venous blood signal, isolates it, and using adaptive filters, cancels the noise and extracts the arterial signal. It then reports the true arterial oxygen saturation and pulse rate. Conventional pulse oximetry provides inaccurate monitoring or signal dropout during patient motion or movement, low perfusion resulting in low signal amplitude, intense ambient light due to indoor lighting or sunlight, and electro surgical instrument interference. Advanced pulse oximetry works accurately where conventional pulse oximetry tends to fail. An advanced pulse oximeter is described in U.S. Pat. No. 6,501,975 entitled “Signal Processing Apparatus and Method,” which is assigned to Masimo Corporation, Irvine, Calif. and incorporated by reference herein.

Unlike generic sensors designed for conventional pulse oximeters, advanced sensors are designed to provide superior performance when used with advanced pulse oximeters. Advanced sensors are designed for very low signal to noise situations, including low perfusion and motion artifact. Advanced sensors also perform well under other difficult conditions such as electromagnetic interference, including electro-cautery devices and ambient light. Advanced sensor design represents a significant first line of defense against interfering signals, i.e. noise. An advanced pulse oximetry sensor is described in U.S. Pat. No. 6,088,607 entitled “Low Noise Optical Probe,” which is assigned to Masimo Corporation, Irvine, Calif. and incorporated by reference herein.

One aspect of a sensor incentive method provides a sensor adapted to function with an installed base of conventional physiological instruments and associates an incentive with the sensor in connection with a sensor purchase. The incentive is applied to a qualified purchase of advanced physiological instruments so as to motivate the upgrade or replacement of the installed base with advanced physiological instruments. The accumulation of multiple incentives may also apply to the purchase. In one embodiment, a coupon is associated with the sensor purchase, where the coupon has a monetary value applicable to the qualified purchase. The coupon is redeemed for the monetary value during the qualified purchase. A total redemption value for multiple coupons is the product of the number of coupons and the coupon monetary value. A particular embodiment of the sensor incentive method is applicable to motivate the upgrade or replacement of an installed base of conventional pulse oximeters with advanced pulse oximeters.

Another aspect of a sensor incentive method is associating a coupon having a monetary value with a sensor purchase. The cash value is multiplied by the number of accumulated coupons to yield a redemption value. The redemption value is then applied to a qualified pulse oximeter purchase. In one embodiment, the coupon is packaged with a generic or advanced sensor so as to provide an incentive to upgrade or replace an installed base of conventional pulse oximeters with advanced pulse oximeters. In another embodiment, the coupon is packaged with an advanced sensor so as to provide an incentive to expand an installed base of advanced pulse oximeters.

A further aspect of a sensor incentive method comprises offering a sensor at an actual price and associating a coupon having a monetary value with the sensor. The coupon is redeemed in conjunction with a purchase of a qualified physiological measurement product so that the sensor has an effective price of the actual price less the monetary value that is competitive with market prices.

Yet another aspect of a sensor incentive method comprising offering a plurality of sensors for use with conventional physiological instruments, wherein the sensors have a range of grades and are priced according to the grades. Coupons are defined having a range of monetary values applicable to the purchase of a qualified product. The coupons are associated with the sensors so that said monetary values correspond to said grades.

### BRIEF DESCRIPTION OF THE DRAWINGS

FIG. 1 is a block diagram of a prior art pulse oximetry system;

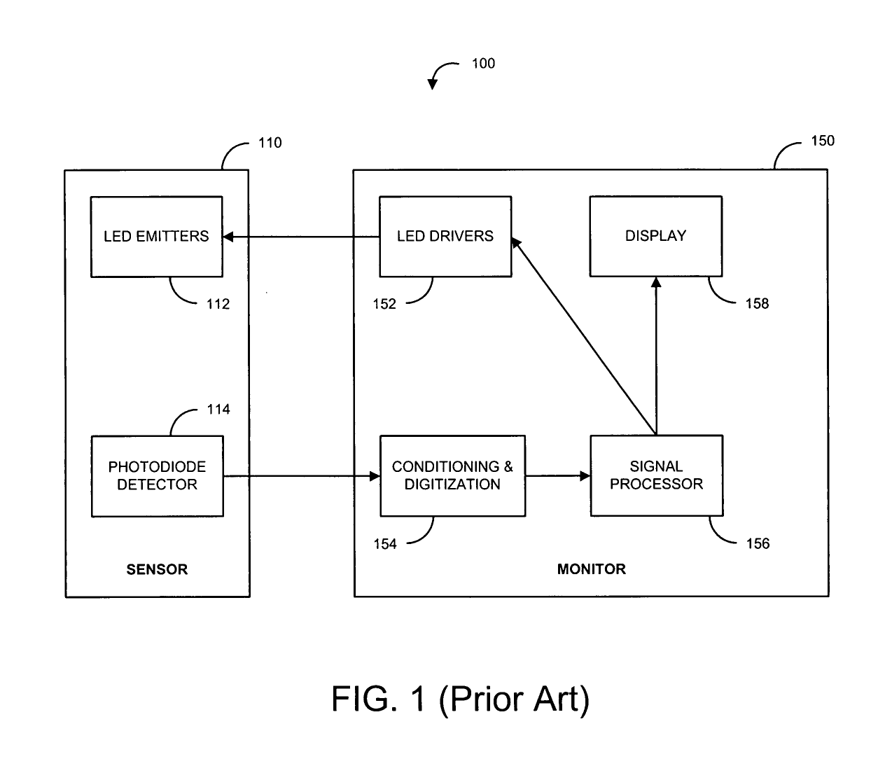

FIG. 2 is a general flow diagram of a sensor incentive method for upgrading an installed base of conventional physiological instruments to advanced physiological instruments;

FIG. 3 is a flow diagram of a sensor incentive method utilizing a coupon-based incentive associated with a sensor purchase;

FIG. 4 is a bar chart illustrating the relative pricing of a competition sensor and a coupon sensor; and

FIG. 5 is a bar chart illustrating relative pricing for a range of generic and advanced coupon sensors.

### DETAILED DESCRIPTION OF THE PREFERRED EMBODIMENT

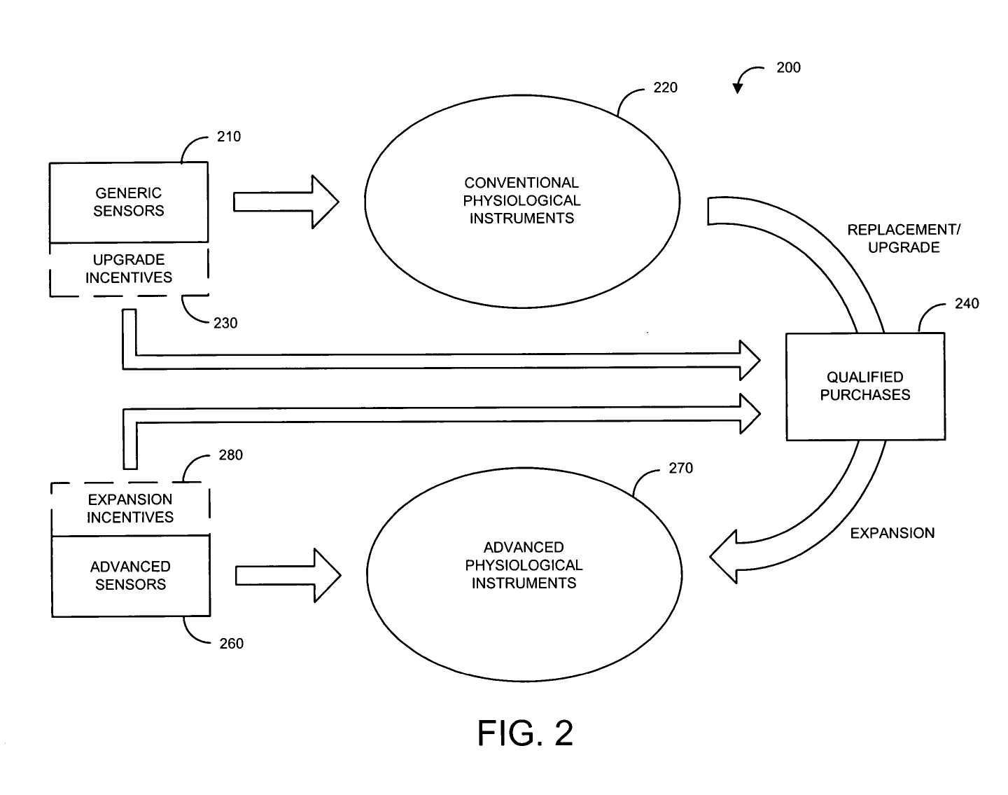

FIGS. 2-5 illustrate a sensor incentive method that advantageously associates a temporary incentive with a sensor purchase so as to motivate, facilitate or otherwise enable healthcare personnel, hospitals and other healthcare institutions, and other end users to replace or upgrade their installed base of conventional physiological instruments in favor of advanced physiological instruments. Such a replacement or upgrade provides superior performance and advanced features for measuring and monitoring physiological parameters. Advantageously, a sensor incentive method is applicable to the purchase of generic and advanced sensors for use with conventional physiological instruments, advanced physiological instruments or a mixture of conventional and advanced physiological instruments.

FIG. 2 illustrates a sensor incentive method 200 having generic sensors 210 that are supplied to an installed base of conventional physiological instruments 220. Upgrade incentives 230 are associated with the generic sensors 210, which can be applied to qualified purchases 240 of advanced physiological instruments. In one embodiment, the upgrade incentives 230 are provided to purchasers of the generic sensors 210 and function to discount the qualified purchases 240. In one embodiment, these incentives 230 expire after a predetermined time period.

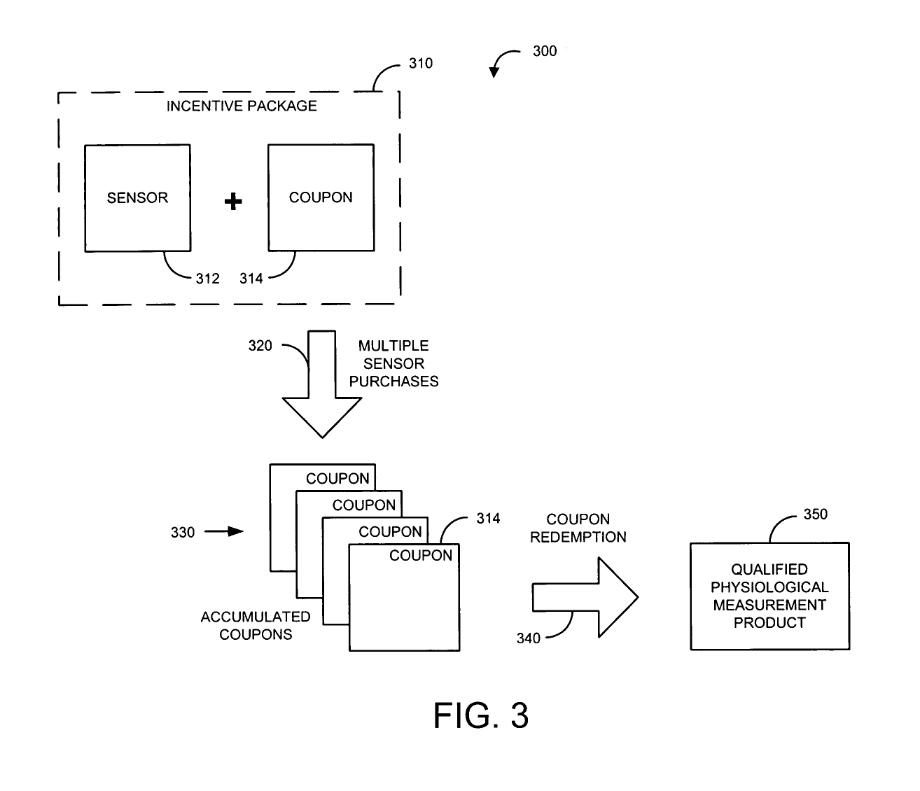

Also illustrated in FIG. 2, the sensor incentive method 200 may also have advanced sensors 260 that are supplied to an installed base of advanced physiological instruments 270. Expansion incentives 280 are associated with the advanced sensors 260, which can also be applied to a qualified purchase 240. In one embodiment, the expansion incentives 230 are provided to purchasers of the advanced sensors 260 and, like the upgrade incentives 230, function to discount the qualified purchases 240. In another embodiment, the expansion incentives 230 may take the same form as the upgrade incentives 230, as described in more detail with respect to FIGS. 3-5, below.

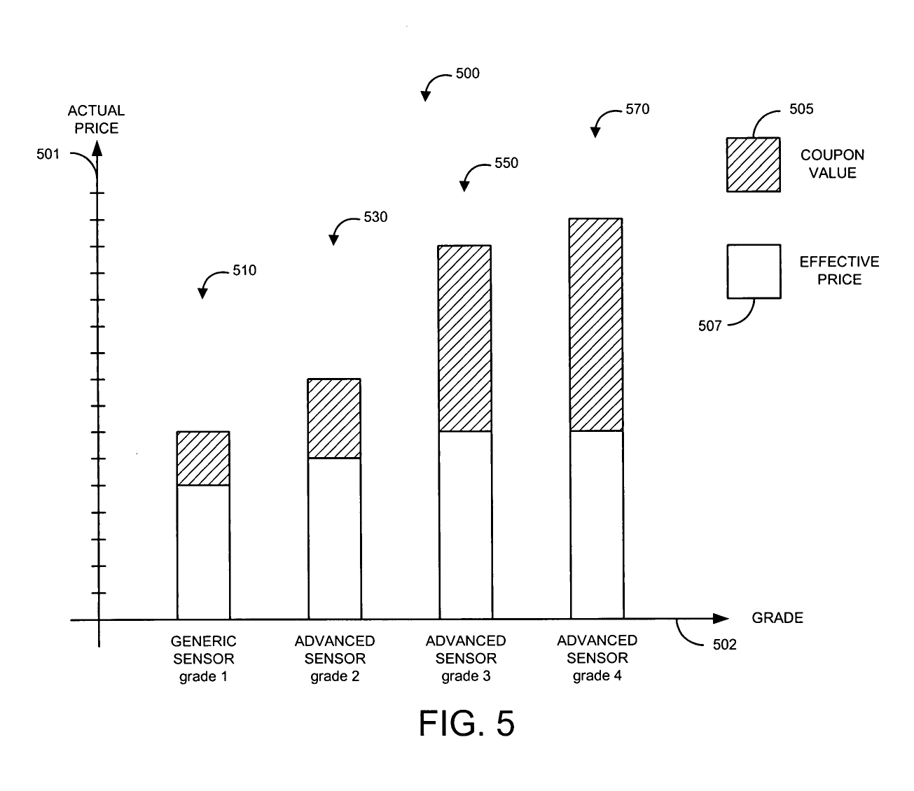

Although not explicitly shown in FIG. 2, the sensor incentive method 200 may also have both generic sensors 210 and advanced sensors 260 supplied to an installed base of conventional physiological instruments 220. For the end user with a mixed installed base of both conventional physiological instruments 220 and advanced physiological instruments 270, purchasing advanced sensors 260 has the advantage of standardizing on a limited number of sensor types for use on the entire installed base. Further, the advanced sensors 260 may provide superior performance even on conventional physiological instruments 220. For the manufacturer, supplying advanced sensors 260 for either conventional instruments 220 or a mix of conventional instruments 220 and advanced instruments 270 in itself motivates, facilitates or otherwise enables the end user to replace or upgrade the conventional physiological instruments 220 to advanced physiological instruments 270, on which the advanced sensors 260 would provide superior performance. The upgrade incentives 230 may be different in magnitude and scope when applied to the generic sensors 210 as compared with advanced sensors 260, such as described with respect to FIG. 5, below.

As shown in FIG. 2, physiological instruments 220, 270 may include a variety of devices designed to measure physiological parameters, such as pulse oximeters, blood pressure monitors, temperature monitors, ECG and EEG monitors to name just a few. Similarly, sensors may include a variety of devices that respond to physiological parameters and/or transmit physiological signals to the physiological instruments, such as pulse oximetry sensors; blood pressure cuffs; transducers; ECG, EEG and other types of electrodes; and similar devices.

FIG. 3 illustrates a sensor incentive method 300 having an incentive package 310, multiple sensor purchases 320, accumulated coupons 330, coupon redemption 340 and a qualified physiological measurement product 350. The incentive package 310 includes a sensor 312 and one or more associated coupons 314 each having a coupon redemption value. The coupons can be physical, electronic or any other form that can convey a restricted monetary value, where the restrictions include product applicability and expiration date to name a few. Multiple sensor purchases 320 result in accumulated coupons 330 having a total redemption value. In one embodiment, the total redemption value is equal to the sum of the individual coupon redemption values. Coupon redemption 340 occurs with the purchase of the qualified product 350. In one embodiment, the qualified product 350 is an advanced pulse oximeter having motion tolerant capability, and the purchase price of the qualified product 350 is reduced by the total redemption value. In a particular embodiment, the sensor 312 is a generic sensor adapted to a conventional pulse oximeter so that the coupon provides an incentive to the sensor purchaser to upgrade or replace conventional pulse oximeters with advanced pulse oximeters.

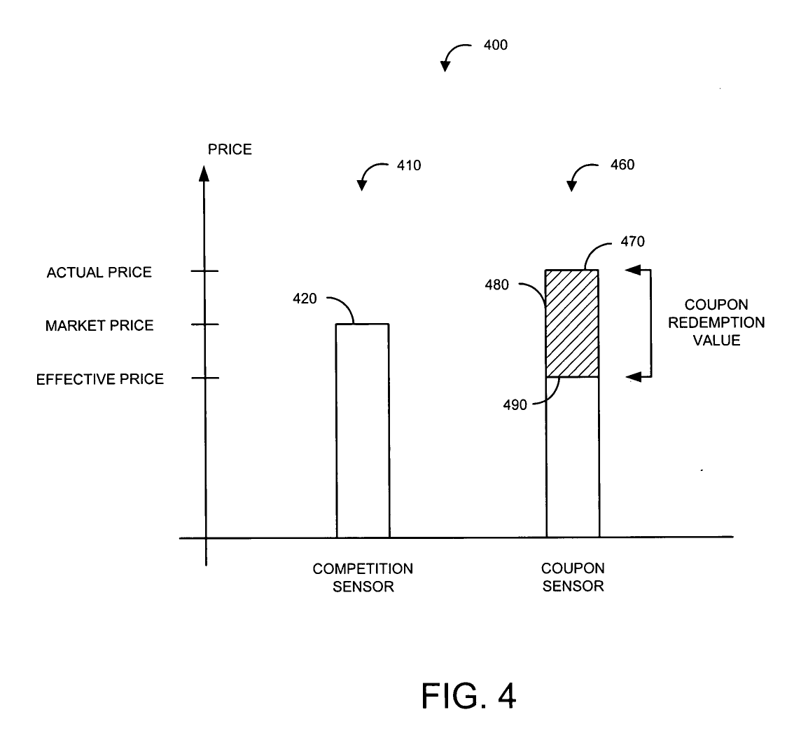

FIG. 4 illustrates a sensor incentive method 400 having a competition sensor 410, i.e. a generic sensor supplied by any of a variety of competing manufacturers or vendors and a coupon sensor 460, i.e. a sensor having an associated coupon, as described with respect to FIG. 3, above. The competition sensor 410 has a market price 420. The coupon sensor 460 has an actual price 470, a coupon redemption value 480 and an effective price 490. The effective price is defined as the actual price 470, i.e. sensor purchase price, less the coupon redemption value 480, which applies toward the purchase of a qualified physiological measurement product, as described above. In one embodiment, the sensor incentive method 400 allows the actual price 470 of an advance sensor to be left unaltered when positioned to compete with a generic sensor. Instead, the effective price 490 is adjusted with a coupon that is issued so that the coupon sensor is competitive with the market price 420 and motivates, facilitates or otherwise enables the purchase of advanced physiological instruments and corresponding advanced sensors.

FIG. 5 illustrates a sensor incentive method 500 having a variety of sensors 510-570 each having an actual price 501 and a grade 502. The actual price 501 is an effective price 507 plus a coupon value 505, as described with respect to FIG. 4, above. A generic sensor 510 is at the lowest grade 502 and corresponding lowest actual price 501. Advanced sensors 530-570 are at higher grades 502 and corresponding higher actual prices 501. Both generic sensors 510 and advanced sensors 530-570 are offered for an installed base of conventional physiological instruments, as described above. Further, both generic sensors 510 and advanced sensors 530-570 are provided with a coupon to provide an incentive to upgrade or replace these conventional instruments with advanced instruments. Advantageously, the coupon value 505 increases with increasing grade 502. In this manner, the effective price 507 of even the highest grade sensors can be made competitive with the market price of generic sensors without altering the actual price. In one embodiment, the sensors 510-570 are pulse oximeter sensors, and the grade 502 varies with such things as noise performance, disposable sensor adhesive quality, and plug compatibility to name a few.

A sensor incentive method has been disclosed in detail in connection with various embodiments. These embodiments are disclosed by way of examples only and are not to limit the scope of the claims that follow. One of ordinary skill in art will appreciate many variations and modifications.

1. A sensor incentive method comprising the steps of:
providing a sensor adapted to function with an installed base of conventional physiological instruments;
associating an incentive with said sensor in connection with a sensor purchase; and
applying said incentive to a qualified purchase of advanced physiological instruments so as to motivate the upgrade or replacement of said installed base with said advanced physiological instruments.

2. The sensor incentive method according to claim 1 further comprising the step of enabling multiple ones of said incentive to apply to said qualified purchase.

3. The sensor incentive method according to claim 2 wherein said associating step comprises the substep of supplying a coupon with said sensor purchase, said coupon having a monetary value applicable to said qualified purchase.

4. The sensor incentive method according to claim 3 wherein said applying step comprises the substep of redeeming said coupon for said monetary value during said qualified purchase.

5. The sensor incentive method according to claim 4 wherein said enabling step comprises the substep of assigning a total redemption value to said multiple ones of said incentive equivalent to the product of the number of said multiple ones and said monetary value.

6. The sensor incentive method according to claim 5 wherein said conventional physiological instruments and said advanced physiological instruments are pulse oximeters.

7. A sensor incentive method comprising the steps of:
associating a coupon having a monetary value with a sensor purchase,
multiplying said cash value by the number of accumulated ones of said coupon to yield a redemption value; and
applying said redemption value to a qualified pulse oximeter purchase.

8. The sensor incentive method according to claim 7 wherein said associating step comprises the substep of packaging said coupon with a generic sensor so as to provide an incentive to upgrade or replace an installed base of conventional pulse oximeters with advanced pulse oximeters.

9. The sensor incentive method according to claim 7 wherein said associating step comprises the substep of packaging said coupon with an advanced sensor so as to provide an incentive to expand an installed base of advanced pulse oximeters.

10. The sensor incentive method according to claim 7 wherein said associating step comprises the substep of packaging said coupon with an advanced sensor so as to provide an incentive to upgrade or replace an installed base of conventional pulse oximeters with advanced pulse oximeters.

11. A sensor incentive method comprising the steps of:
offering a sensor at an actual price;
associating a coupon having a monetary value with said sensor; and
redeeming said coupon in conjunction with a purchase of a qualified physiological measurement product so that said sensor has an effective price of said actual price less said monetary value that is competitive with market prices.

12. A sensor incentive method comprising the steps of:
offering a plurality of sensors for use with conventional physiological instruments, wherein said sensors has a range of grades;
pricing each of said sensors according to said grades;
defining a plurality of coupons having a range of monetary values applicable to the purchase of a qualified product; and
associating said coupons with said sensors so that said monetary values correspond to said grades.
